(19) United States
(12) Patent Application Publication
(10) Pub. No.: US 2013/0066031 A1
(43) Pub. Date: Mar. 14, 2013

(54) MICROMOLDING OF POLYSTYRENE BY SOFT LITHOGRAPHY

(71) Applicants: Nancy Allbritton, Chapel Hill, NC (US); Christopher Sims, Chapel Hill, NC (US); Yuli Wang, Cary, NC (US)

(72) Inventors: Nancy Allbritton, Chapel Hill, NC (US); Christopher Sims, Chapel Hill, NC (US); Yuli Wang, Cary, NC (US)

(21) Appl. No.: 13/596,603

(22) Filed: Aug. 28, 2012

Related U.S. Application Data
(60) Provisional application No. 61/532,223, filed on Sep. 8, 2011.

(51) Int. Cl. B28B 11/08; C08F 120/10; C08G 63/08; C08F 112/08

(52) U.S. Cl. 526/329.7; 264/293; 526/346; 528/272

(57) ABSTRACT

A method of making such is carried out by (a) providing a reverse template for said article, said template comprising an elastomeric polymer such as PDMS; (b) providing a solution comprising a polymer dissolved in a first solvent; wherein said polymer is selected from the group consisting of polystyrene, poly(methyl methacrylate), epoxy, and aliphatic polyesters; and wherein said solvent comprises a lactone; (c) depositing said solution on said template; (e) removing said solvent from said template to form said article from said polymer on said template; and then (f) separating said template from said article.

### RELATED APPLICATIONS

This application claims the benefit of U.S. Provisional Patent Application Ser. No. 61/532,223, Filed Sep. 8, 2011, the disclosure of which is incorporated by reference herein in its entirety.

### STATEMENT OF FEDERAL SUPPORT

This invention was made with US government support under grant nos. HG4843 and EB7612 from the National Institutes of Health. The US government has certain rights to this invention.

### FIELD OF THE INVENTION

The present invention concerns methods for carrying out soft lithography.

### BACKGROUND OF THE INVENTION

Polystyrene has numerous distinct advantages as a polymer for biological applications including low cost, optical clarity, biocompatibility, chemical inertness, chemical stability, rigidity, and versatility of chemical functionalization of surface and bulk properties. These advantages make polystyrene the most popular material for the fabrication of cell culture labware including tissue-culture dishes, flasks, and multiwell plates.¹

By virtue of its properties and advantages, polystyrene would be an ideal material for creating miniaturized lab-on-a-chip devices, which are anticipated to have wide-ranging applications in diagnostics, therapeutics, and bio-analytical assays.² To fabricate such miniaturized devices, a convenient and repeatable microfabrication process is needed for creating intricate microscale patterns into a polystyrene substrate with high resolution and reproducibility.

Conventional microfabrication processing steps, e.g. etching, deposition, and lithography, originally developed for inorganic substrates such silicon, glass, and quartz, are not suitable for microfabrication of polystyrene material due to differences in polystyrene's physical properties from that of its inorganic counterparts^{.3, 4} For example, polystyrene is not compatible with a lithography processing step because it is neither resistant to the solvents present in resists nor heat tolerant to the resist bake. Hot embossing, injection molding, thermalforming, and indentation against a rigid master can be used to create small patterns into thermoplastics.⁵ These methods have been demonstrated for thermoplastics such as poly(methyl methacrylate) (PMMA) and cyclic olefin copolymer (COC),^{6, 7} and conceivably they are applicable to polystyrene. However, these fabrication methods require dedicated tools such as hot-press or injection molding machines and expensive master molds. In these processes, both the polymers and the master are rigid; therefore, it is difficult to detach the molded polymer from a master without damaging the intricate micropatterns, especially for the high-aspect ratio microstructures. As a result, these processing methods have not gained favor in creating polystyrene lab-on-a-chip devices, although a few examples have been described in fabricating polystyrene microfluidic devices.^{8, 9}

A non-conventional fabrication method called “Shrinky-Dink” was used to fabricate polystyrene microfluidics from biaxially pre-stressed polystyrene sheets:¹⁰ The features were drawn on the sheets by mechanical scribing or ink jet printer. Heating causes the inscribed films to shrink to their original size, while the drawn features become narrower and more raised, creating a microstructured surface. Although it is a rapid, benchtop process, it is not possible to control the accuracy and resolution of the microstructures.

Soft lithography is a technique for fabricating or replicating small structures using elastomeric stamps and molds created from polydimethylsiloxane (PDMS), polyurethane and like polymers.¹¹ It is a simple benchtop process that does not require sophisticated tools, and therefore it has gained widespread acceptance in academic research for creating lab-on-a-chip devices:^{12, 13} For replica molding, a liquid polymer precursor is poured onto a PDMS mold and the polymer is allowed to cure. Then the PDMS mold is detached from the solidified polymer with the microstructure pattern on the PDMS mold being replicated into the polymer.

Polymer materials that can be replicated by soft lithography so far described include PDMS itself, polyurethane, epoxy, as well as a number of other polymers^{.11, 12} PDMS is the most popular material for soft lithography due to the ease of the liquid molding process and its numerous advantages, although a variety of elastomer can be used including other silicone rubbers, urethane rubbers, and ethylene-vinyl acetate (EVA) rubbers.^{14, 15} However, PDMS (and other elastomers) when used not as the mold, but for the actual lab-on-a chip devices, has intrinsic limitations, for example, unstable surface property (post-oxidation hydrophobic recovery),^{16, 28} leaching of low molecular weight species,¹⁷ undesired absorption of hydrophobic molecules,¹⁸ low rigidity, and high solubility of gases.¹⁹

For the various reasons discussed above, it would be of potentially great advantage to apply soft lithography processing in microfabrication of polystyrene, and other materials soluble in organic solvents such polylactide, by combining both the advantages of polystyrene as a material with the convenience of soft lithography. Since polystyrene is complementary in many of its properties to PDMS, for example, rigidity, lack of non-specific absorption of hydrophobic molecules, stable surface property after oxidation, no leaching of low molecular species, high biocompatibility, and low solubility of gases (i.e. low gas permeability), it would be an ideal alternative material for building lab-on-a-chip devices. However, to be processed by soft lithography, polystyrene must be deformable in order to be replicated by a PDMS mold. Polystyrene can be heated to a melting (T>Tm) or rubber-like (T>Tg) state for replica molding. For example, polystyrene has been hot embossed against a PDMS master at 180° C. to create a microstructured chip for culture of single cells.²⁰ The elasticity and low surface energy of the PDMS mold allows it to be released easily from polystyrene, but it was not possible to emboss microscale features with aspect ratios higher than 2 because of the deformation of the PDMS master during the embossing process.²⁰ Alternatively, a liquid precursor of polystyrene (e.g. styrene monomer), or a polystyrene solution in an organic solvent could be used for replica molding; however, it has been found that the monomer styrene quickly swells and distorts a PDMS mold, as do typical organic solvents used for dissolving polystyrene.²¹ Highly fluorinated perfluoropolyether (PFPE) elastomer has excellent solvent resistance and has been demonstrated to be an excellent molding material for soft lithography, but the precursors of this elastomer are not commercially available for replica molding.^{22, 23}

Therefore, the search of a solvent that can dissolve polystyrene, but does not swell molds created from PDMS and other elastomers that swell in the presence of organic solvents including other silicone rubbers, urethane rubbers, and ethylene-vinyl acetate (EVA) rubbers, is crucial in the application of soft lithography for polystyrene and other materials dissolved in an organic solvent.

### SUMMARY OF THE INVENTION

The present invention is based in part on the finding that GBL can completely dissolve polystyrene, but does not swell PDMS; therefore, it serves as an ideal solvent that enables micromolding of polystyrene by soft lithography technology. We have reduced to practice the micromolding of a variety of polystyrene microstructures with high resolution and high fidelity demonstrating its broad applicability. Importantly, a number of high resolution and high-aspect-ratio structures were fabricated, which would be very difficult to be accomplish using other methods, but were easily fabricated using this micromolding process. A prototype polystyrene microfluidic chip was built that showed much lower non-specific absorption of hydrophobic molecules than a device composed of PDMS. The invention herein described is a process for micromolding polystyrene that that does not require any dedicated or costly instrumentation. All of the raw materials are readily available from standard commercial sources. With numerous the advantages of polystyrene as a material for biological applications, such as stable surface properties after oxidation, no leaching of low molecular weight species and high biocompatibility, polystyrene represents a superlative alternative material for building lab-on-a-chip devices.

The present invention provides a method of making an article or product. The method comprises:

(a) providing a reverse template for the article, the template comprising an elastomeric polymer such as a silicone polymer;

(b) providing a solution comprising a polymer dissolved in a first solvent, the solvent preferably comprising a lactone solvent;

(c) depositing the solution on the template;

(e) removing the solvent from the template to the article from the polymer on the template; and then

(f) separating the template from the article.

The present invention is explained in greater detail in the drawings herein and the specification set forth below. The disclosures of all US Patent references cited herein are to be incorporated by reference herein in their entirety.

### BRIEF DESCRIPTION OF THE DRAWINGS

FIG. 1. Schematic of micromolding polystyrene by soft lithography. (A) Polystyrene petri dish was cut into pieces and dissolved in GBL to form a 25 wt % solution. (B) The polystyrene solution was poured into a PDMS mold, degassed, and baked to evaporate the GBL solvent. (C) The PDMS mold was released from the solidified polystyrene.

FIG. 2. Swelling test of PDMS by solvents. (A) A PDMS slab exposed to polystyrene dissolved in toluene. (B) A PDMS slab exposed to polystyrene solution in GBL. In both “A” and “B”, 2 mL of polystyrene solution (25 wt % in solvent) was added to PDMS. The toluene solution swelled and distorted the PDMS slab within 5 min, while the GBL solution showed no swelling or distortion of the PDMS slab after 2 h.

FIG. 3. Microstructures created by micromolding polystyrene. (A) An array of 550,000 microwells. (B) Microwells (12.5 μm diameter, 5 μm inter-well gap, 20 μm depth). (C) Pillar array (10 μm diameter, 30 μm height). (D) Cross ridge (50 μm width, 50 μm height). (E) Pillars with an aspect ratio >7 (30 μm diameter, 215 μm height). (F) Microwells with high aspect ratio (30 μm diameter, 215 μm depth).

FIG. 4. Polystyrene microfluidic chip. (A) Schematic of thermal bonding to form an enclosed microfluidic channel. (B) A prototype of polystyrene microfluidic chip. (C) An open microchannel (50 μm width, 50 μm depth). (D) Leakage test by filling the enclosed microfluidic channel with 10 mM rhodamine B shows that the red fluid is retained in the channels.

FIG. 5. Rhodamine B absorption tests. Fluorescence images of polystyrene (A and B) and PDMS (C and D) devices are shown. The channels on these devices are filled with 100 μM RhB in water for 15 min, then rinsed with water. Fluorescent profiles of the polystyrene and PDMS channels are also shown in E and F, respectively. These profiles were taken along the white dotted line in images A-D.

FIG. 6. H1299 cell culture on three surfaces. (A) TC dish. (B) Molded polystyrene. (C) PDMS. Cell loading density was 100 cells/cm² and culture time is 72 h.

FIG. 7. Micromolding polymers on PDMS mold by using compatible solvent. (A) SEM image of a hollow square pattern created in polystyrene by soft lithography using gamma-valerolactone (GVL) as solvent. (B) SEM image of a porous, microwell pattern created in poly (DL-lactide) by soft lithography using gamma-butyrolactone (GBL) as solvent.

### DETAILED DESCRIPTION OF THE PREFERRED EMBODIMENTS

“Lactone” as used herein refers to a cyclic ester which can be seen as the condensation product of an alcohol group —OH and a carboxylic acid group —COOH in the same molecule. It is characterized by a closed ring consisting of two or more (e.g., 2, 3 or 4 to 5, 7 or 9) carbon atoms and a single oxygen atom, with a ketone group ═O in one of the carbons adjacent to the other oxygen. The ring may optionally be substituted, for example with hydroxyl and/or C1-C4 alkyl. Example lactones include, but are not limited to, propiolactone, butyrolactone, valerolactone, caprolactone, etc.

“Aliphatic polyester” polymers are known and described in, for example, U.S. Pat. Nos. 7,994,078; 6,953,622; and 5,976,694, the disclosures of which are incorporated by reference herein in their entirety. Examples include, but are not limited to polyhydroxy butyrate (PHP), polyhydroxy butyrate-co-valerate (PHBV), polycaprolactane, polybutylene succinate, polybutylene succinate-co-adipate, polyglycolic acid (PGA), polylactide or polylactic acid (PLA), polybutylene oxalate, polyethylene adipate, polyparadioxanone, polymorpholineviones, or polydioxipane-2-one, and combinations or copolymers thereof.

“Epoxy polymer” as used herein may be any suitable epoxy polymer, including but not limited to those described in U.S. Pat. Nos. 7,981,511; 7,888,257; 7,821,719; 7,771,468; and 7,723,405.

“Elastomeric polymer” as used herein includes, but is not limited to, silicone rubbers such as polydimethylsiloxane, urethane rubbers, and ethylene-vinyl acetate (EVA) rubbers.

As noted above, the present invention provides a method of making an article or product. The method comprises:

(a) providing a reverse template for the article, the template comprising an elastomeric polymer such as a silicone polymer;

(b) providing a solution comprising a polymer dissolved in a first solvent (for example, a polystyrene, poly (methyl methacrylate), epoxy, or aliphatic polyester polymer); and the solvent preferably comprising a lactone;

(c) depositing the solution on the template;

(e) removing the solvent from the template to the article from the polymer on the template; and then

(f) separating the template from the article.

The step of removing the first solvent from the template (or separating the solvent from the polymer dissolved or solubilized therein) can be carried out by any suitable technique, including vacuum drying, air drying, and/or baking the template.

In some embodiment, the step of removing the first solvent may comprise contacting the template to a second solvent (e.g., an aqueous solvent), wherein the first solvent is miscible in said the solvent, and the polymer is immiscible in the second solvent, to thereby form a porous article. This contacting step can then be followed by vacuum drying, air drying, and/or baking of the template to remove the first and second solvents.

In some embodiments, the first solvent comprises gamma-butyrolactone and/or gamma-valerolactone.

In some embodiments, the polymer dissolved or solubilized in the first solvent comprises polystyrene, poly(methyl methacrylate), an epoxy polymer, or an aliphatic polyester.

Examples of particular solute and solvent combinations for carrying out the present invention include, but are not limited to, those set forth in Table A below.

TABLE A
Materials for raft fabrication and liquid micromolding

| Solute | Solvent | Process conditions |
|---|---|---|
| Polystyrene | gamma-Butyrolactone | Solidification via solvent |
| | Dimethylformamide | evaporation |
| | N-Methylpyrrolidone | |
| Poly(styrene-co-acrylic acid) | gamma-Butyrolactone | Solidification via solvent |
| | Dimethylformamide | evaporation |
| | N-Methylpyrrolidone | |
| Epoxy (e.g. EPON SU-8, | gamma-Butyrolactone | Solidification via solvent |
| 1002F and 1009F resin) | | evaporation |
| Biodegradable polymers (e.g. | gamma-Butyrolactone | Solidification via solvent |
| poly(dl-lactide), poly(dl- | | evaporation |
| lactide/glycolide)) | | |
| Hydro gel (e.g. polyethylene | Water | Solidification via thermal or photo |
| glycol diacrylate) | | induced crosslink reaction |
| Biopolymers (e.g. chitosan, | Water | Solidification via pH change (e.g. |
| collagen, Matrigel) | | neutralization) |
| Ceramics (e.g. sodium | Water | Solidification via solvent |
| silicate) | | evaporation |
| Porous materials (e.g. | gamma-Butyrolactone | Solidification through leaching out |
| polystyrene, epoxy, poly(dl- | Dimethylformamide | solvent in a second solvent (e.g. |
| lactide)) | N-Methylpyrrolidone | water). Since the solvent is miscible |
| | | with water, the leaching out of |
| | | solvent leaves porous structures. |
| | | Water does not dissolve the |
| | | material. |
| cyclic olefin copolymer | Propylene glycol methyl | Solidification via solvent |
| | ether acetate | evaporation |
| | Anisole | |
| | Cyclopentanone | |
| polycarbonate | Propylene glycol methyl | Solidification via solvent |
| | ether acetate | evaporation |
| | Anisole | |
| | Cyclopentanone | |
| Poly(methyl methacrylate) | Propylene glycol methyl | Solidification via solvent |
| | ether acetate | evaporation |
| | Anisole | |
| | Cyclopentanone | |

A variety of different articles may be produced by the methods of the present invention,

In some embodiments, the article has a plurality of features formed thereon (and, the reverse template has a corresponding plurality of features formed therein). In some embodiments, the features have an aspect ratio greater than 2, 3, 4, 5, or 6. In some embodiments, the article has at least 100, 200, 500 or 1000 features formed thereon, and wherein not more than 50, 20, 10, or (in some embodiments) 1 of said features are defective. The features may be columns, walls, wells, trenches, and combinations thereof. The features may have a height or depth of from 1 μm or 100 μm to 1 mm or 10 mm, and/or a thickness or width of 1 μm or 10 μm to 1 mm or 10 mm.

In some embodiments, the product is porous, the product is comprised of an aliphatic polyester, and the second solvent described above is an aqueous solvent such as water.

Examples of articles that may be produced by the methods of the present invention include, but are not limited to, microfluidic devices, filters, microelectronic devices, microelectromechanical devices, microlenses, waveguides, cell carriers, microparticles (including nanoparticles), and filters.

The present invention is explained in greater detail in the following non-limiting Examples.

### Experimental

We have screened numerous organic solvents for polystyrene solubility and PDMS swelling. In this effort, we discovered that gamma-butyrolactone (GBL) was the only organic solvent found in our screening that could completely dissolve polystyrene while not swelling PDMS. In this work, polystyrene cut from cell culture dishes was dissolved in GBL (25 wt %), and the solution was used for replica molding on a PDMS mold. Polystyrene was solidified by evaporation of GBL in a simple baking step. After detaching the PDMS mold from the solidified polystyrene, the microstructure patterns were transferred to polystyrene. High aspect ratio microstructures could be created simply, with high reproducibility, and fidelity of replication demonstrating that microstructured polystyrene can be fabricated by benchtop soft lithography using readily available materials.

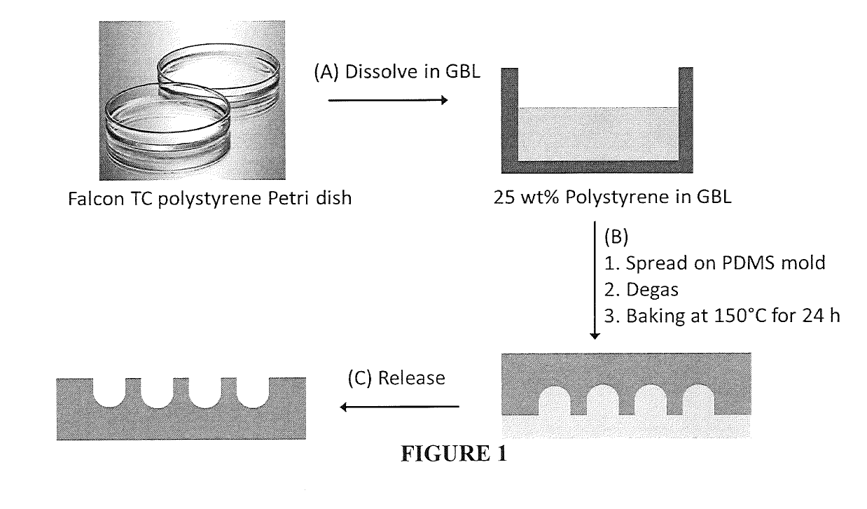

FIG. 1 shows the soft lithography process for micromolding polystyrene. Polystyrene pieces were cut from Falcon™ petri dishes (100×15 mm Style) (BD, Franklin Lakes, N.J.) and dissolved in gamma-butyrolactone (GBL) (Sigma-Aldrich, St. Louis, Mo.) with the concentration of solid being 25 wt %. A PDMS mold was fabricated by casting PDMS on an SU-8 master which was fabricated by standard photolithography on a glass slide with 10-250 μm thick SU-8 as described previously. To prevent dewetting of polystyrene solution during baking, the PDMS mold was treated in an air plasma cleaner (Harrick Plasma, Ithaca, N.Y.) for 1 min. Polystyrene solution was spread on the PDMS mold. The trapped air bubbles were removed by degassing under vacuum using an oil pump for 1 min. The PDMS mold was then placed on a hotplate at 150° C. for 16 h to completely evaporate GBL solvent from the molded material. Finally, the PDMS mold was slowly peeled from the solidified polystyrene, with micropatterns left on the polystyrene with a high fidelity of replication.

### Results and Discussion

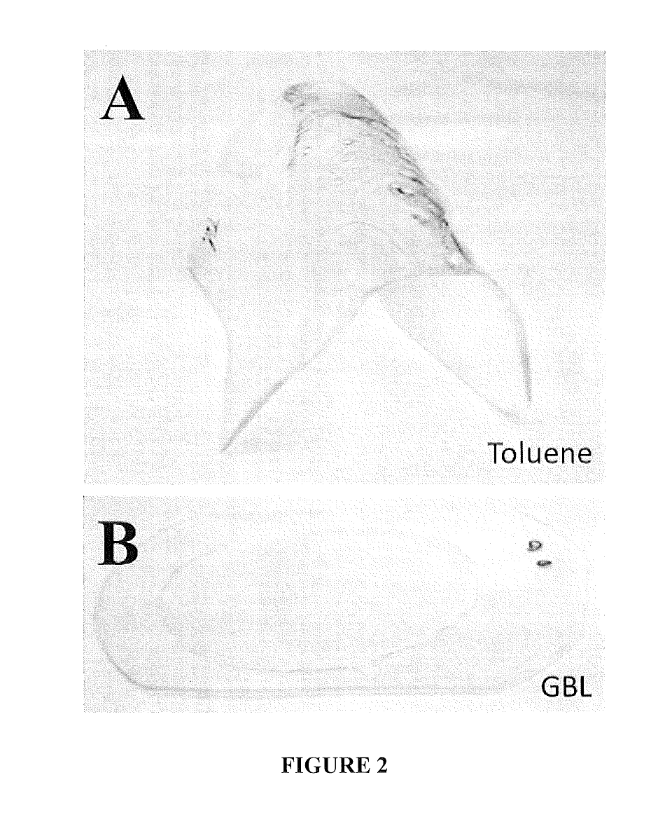

Screening of organic solvents for soft lithography of polystyrene. The ideal solvent suitable for soft lithography would completely dissolve polystyrene, but not swell PDMS. The problem to be overcome is that swelling of the PDMS mold will lead to its distortion and unsuitability for replication. For example, toluene is a well-known solvent for polystyrene, but it quickly swells PDMS. When 2 mL polystyrene solution (25 wt % in toluene) was added to a PDMS sheet (75 mm×50 mm×0.5 mm), within 5 min the PDMS sheet curled up due to the swelling caused by the toluene (FIG. 2A). A variety of additional organic solvents including hexane, chloroform, xylene, ethyl acetate, propylene glycol methyl ether acetate, and acetone were screened for their ability to swell PDMS. Solvent compatibility of PDMS has also been studied by others with 38 different organic solvents including aliphatic hydrocarbons, aromatic hydrocarbons, fluorocarbons, chlorides, alcohols, ethers, esters, acids, and amines being measured for their ability to swell PDMS.21 In that study, solvents that swelled PDMS less than did acetone included only water, nitromethane, dimethyl sulfoxide (DMSO), ethylene glycol, perfluorotributylamine, perfluorodecalin, acetonitrile, propylene carbonate, phenol, methanol, and dimethylformamide (DMF). We then tested those solvents as candidates for soft lithography; however, none could dissolve polystyrene. Those solvents in which PDMS showed minimal swelling were then screened for their ability to solubilize polystyrene In our previous work, we demonstrated that PDMS showed very little swelling in the presence of the organic solvent gamma-butyrolactone (GBL). In that work GBL was used as a solvent for micromolding arrays of releasable polymer elements for cell sorting.24, 25 To quantify PDMS swelling in the presence of GBL, a slab of PDMS (20 mm×20 mm×2 mm) was incubated in GBL for 15 min, and the swell ratio (defined as the gain in weight of the PDMS) was found to be only 1.0094±0.0005 (n=3). In testing, it was found that polystyrene completely dissolved in GBL at concentrations greater than 40 wt %, although at higher concentrations the resulting solution was too viscous for efficient molding. In further testing, when 2 mL polystyrene solution (25 wt % in GBL) was added to a PDMS sheet (75 mm×50 mm×0.5 mm), even after 2 h at room temperature the PDMS sheet did not show any distortion (FIG. 2B). Of note, due to GBL's high boiling point (204° C.) it evaporated very slowly at room temperature, so that the polystyrene solution did not evaporate during pre-molding manipulation steps (e.g. spreading, degassing). GBL thus showed the unique capacity of solubilizing polystyrene while not swelling PDMS during molding. Consequently, GBL appeared to be an excellent candidate solvent for soft lithography processing of polystyrene.

Replica micromolding of polystyrene by soft lithography. An elastomeric PDMS mold (75 mm×50 mm×0.5 mm) was fabricated by casting PDMS on an SU-8 master fabricated by standard photolithography on a glass slide. The SU-8 thickness was 10-250 μm. Approximately 4 g of polystyrene solution (25 wt % in GBL) was added to the PDMS mold (FIG. 1B). This amount of solution generates a film of approximately 0.25 mm thickness after baking. Polystyrene solution was found to be dewetting on PDMS surface during baking, causing the solution to shrink. To prevent the dewetting, the PDMS mold was treated with air plasma for 1 min prior to the addition of the polystyrene solution. This treatment did not affect the mold release in the final step (FIG. 1C). A short (1 min) degas by oil pump was required to remove the trapped air bubbles in the PDMS mold. Since GBL has a high boiling point of 204° C., polystyrene solution did not evaporate or boil during degassing. The polystyrene solution remained as a clear, viscous solution after degassing. The mold was then heated on a hotplate at 150° C. overnight (16 h) to completely evaporate the GBL solvent. Finally, the PDMS/polystyrene was cooled to room temperature and the PDMS mold was slowly peeled from the solidified polystyrene.

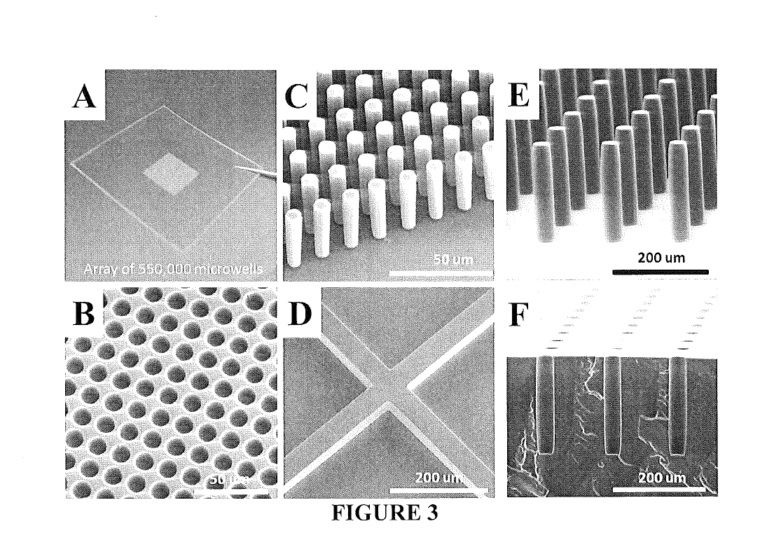

FIG. 3 shows a variety of microstructures created by soft lithography of polystyrene. An array of 550,000 microwells was molded on a polystyrene sheet, with the array area of 13 mm×13 mm (FIG. 3A). The microwells (12.5 μm diameter, 5 μm inter-well gap, 20 μm depth) showed high uniformity across the array (FIG. 3B). This microwell array was created to accommodate single cells for high-throughput single-cell imaging and analysis. To demonstrate the high resolution of micromolding, a small pillar array (10 μm diameter, 30 μm height) was micromolded (FIG. 3C). More complicated structures, such as a cross ridge (50 μm width, 50 μm height) could also be micromolded readily (FIG. 3D). The soft lithography permitted micromolding structures with high aspect ratio, for example, a pillar array with an aspect ratio >7 (30 μm diameter, 215 μm height) can be micromolded without twisting or bending of the pillar (FIG. 3E). Similarly, an array of deep microwells (30 μm diameter, 215 μm depth) with an aspect ratio >7 could be molded (FIG. 3F). It is generally very difficult for other fabrication methods (e.g. microinjection molding, hot embossing) to create microstructures with such high resolution and aspect ratio because of problems with the demolding step. For injection molding and hot embossing, a rigid master (made from nickel, stainless steel, or silicon) is used. It is not possible to detach the rigid master from the rigid polystyrene without causing damage to high-aspect-ratio microstructures. In the method described herein, an elastomeric mold is used. The pliant elastomeric PDMS mold can be detached from the rigid polystyrene structure without causing damage to the high-aspect-ratio microstructures by simply pealing the mold and the patterned polystyrene apart.

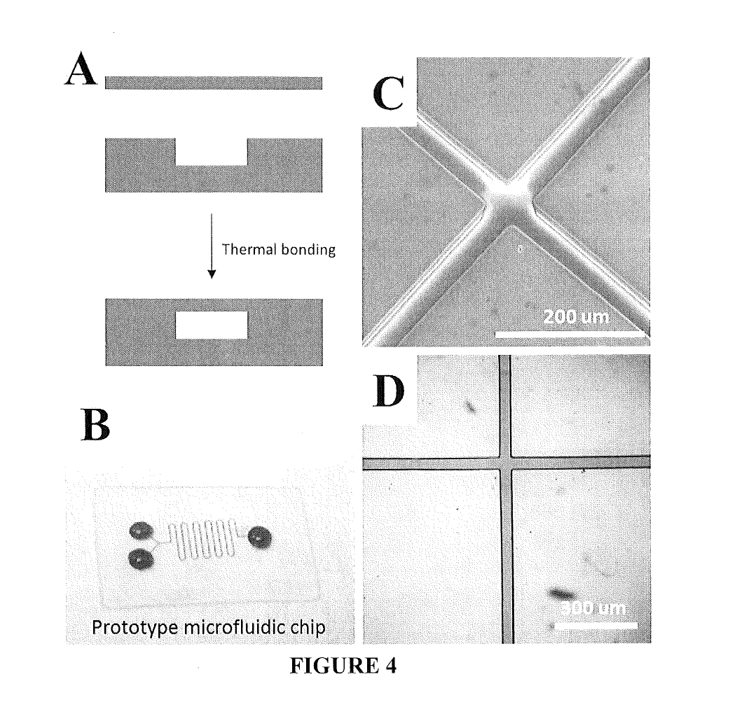

Polystyrene microfluidic chip. One of the most important applications for lab-on-a-chip devices is microfluidic devices. An open microchannel (50 μm width, 50 μm depth) was fabricated by replica micromolding of polystyrene (FIG. 4C). To enclose the channel, a flat polystyrene sheet was bonded on the top of the channel via thermal bonding (FIG. 4A). The flat polystyrene sheet could be obtained by casting polystyrene solution on a flat PDMS sheet and baking at 150° C. for 16 h. The two polystyrene parts were put together, and sandwiched by two glass slides. Clips were used to generate even pressure. The bonding was accomplished by heating at a temperature slightly lower than the glass transition temperature of polystyrene (95° C.). Our initial test shows that baking at 85° C. for 30 min could generate good bonding for the prototype of polystyrene microfluidic chip (FIG. 4B). The optimization of thermal bonding parameters, including pressure, temperature, duration, is ongoing. No leakage was observed for the enclosed microfluidic channel, as indicated by filling the channel with 10 mM rhodamine B in water (FIG. 4D).

Tailoring surface property via copolymerization with other monomers. Surface properties of the material used to create a lab-on-chip device are a vital consideration for many applications of microfluidics due to the high surface-to-volume ratio. As examples, a microfluidic chip used for electrophoresis relies on the surface charge to generate electroosmotic flow, and a microfluidic immunoassay platform needs the proper surface functional groups for the attachment of antibodies. For PDMS, there is no simple, direct route for surface modification. In contrast, the surface properties of polystyrene, as well as its bulk properties, can be tailored simply by copolymerization of styrene with other monomers. Table 1 lists the monomers that could be used to tailor the surface and bulk properties of a polystyrene microfluidic chip. A negative surface charge can be generated by copolymerization of styrene with acrylic acid or 4-styrenesulfonic acid, while a positive surface charge can be generated by using 2-(dimethylamino)ethyl methacrylate. Poly(ethylene glycol) methacrylate can make the surface resistant to protein absorption, while glycidyl methacrylate provides an epoxy functional group for covalent attachment of biomolecules (e.g. proteins). In these examples since the bulk property of polystyrene has been modified by incorporation with other monomers, the surface property would remain extremely stable.

TABLE 1
Examples of monomers that could be used to tailor the
surface property of a polystyrene microfluidic chip.

| Function | Monomer | Functional Group |
|---|---|---|
| Negative Charge | Acrylic acid | Carboxylic acid |
| | 4-Styrenesulfonic acid | Sulfonic acid |
| Positive Charge | 2-(dimethylamino)ethyl | Amine |
| | methacrylate | |
| Protein Resistance | Poly(ethylene glycol) | Poly(ethylene |
| | methacrylate | glycol) |
| Biomolocular | Glycidyl methacrylate | Epoxy |
| Attachment | | |

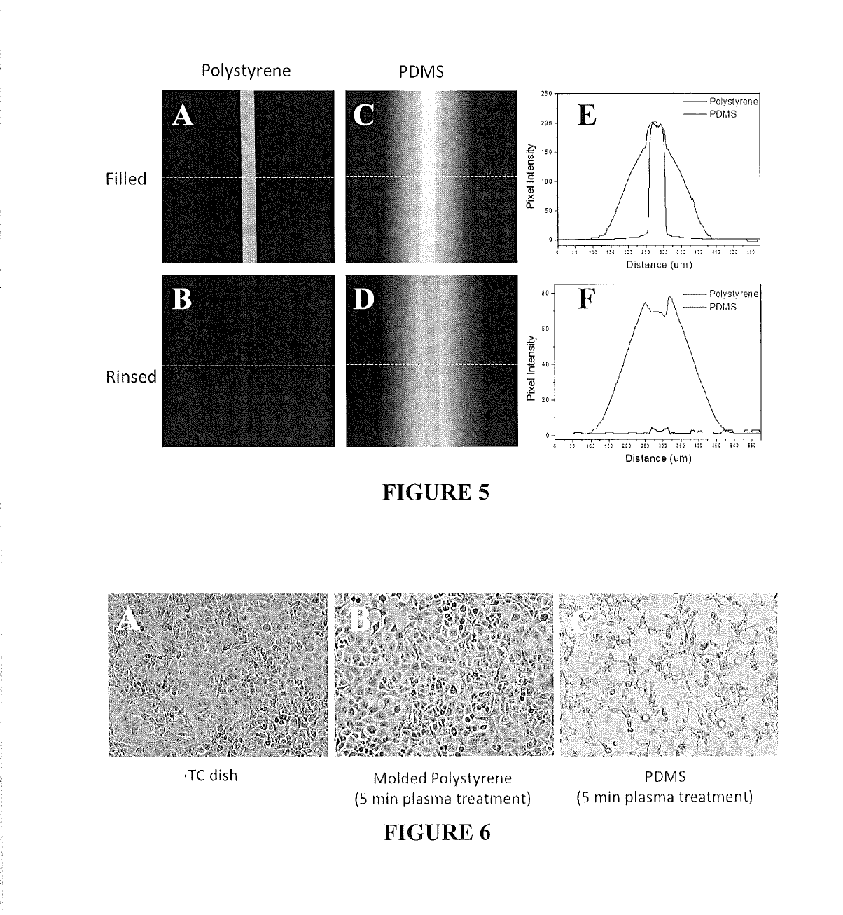

Absorption of hydrophobic species on the surface. An intrinsic weakness of PDMS is that hydrophobic molecules are adsorbed onto its surface and absorbed into the bulk PDMS due to its hydrophobic surface and porous structure.^{18, 26} These properties present significant limitations. For example, adsorption and absorption of biomolecules can lead to carryover between repetitive biological or biochemical assays are performed on a PDMS device. In the case of a PDMS device used for chemical separations, adsorption leads to a variety of problems and limits the analytes that can be chemically separated.²⁷ As an illustration of this problem, a PDMS microfluidic channel (50 μm width, 50 μm depth) was incubated with 100 μM rhodamine B (RhB) for 15 min, after which significant absorption of the dye into the bulk of the PDMS microchip was seen (FIG. 5C). Even after rinsing, the channel exhibited strong fluorescence due to the retention of the dye (FIG. 5D). In contrast when using a microfluidic device composed of polystyrene, RhB did not diffuse into the bulk of the polystyrene when the dye was loaded into the channel (50 μm width, 50 μm depth) and incubated for 15 min (FIG. 5A). After rinsing with water, only a very weak adsorption of RhB was observed on the surface and no fluorescent signal from absorbed dye was detected in the bulk material. Fig. E and F show the quantitative comparison of these results on PDMS and polystyrene chips, both filled with RhB solution and rinsed with water. These data show that compared to PDMS, the polystyrene microchip exhibited dramatically reduced non-specific adsorption and absorption of hydrophobic analytes, which can be expected result in higher detection sensitivity and separation efficiencies.

Cell biocompatibility. Polystyrene is a highly biocompatible material that is widely used as a material for cell culture consumable labware and the vast majority of tissue-culture (TC) dishes, flasks, and multiwell plates, are made from polystyrene. Native polystyrene has a hydrophobic surface, which shows low cell attachment so that polystyrene cell culture wares are generally surface modified with plasma or corona treatment to generate a hydrophilic and ionic (negatively-charged) surface, thus improving cell attachment and spread.¹

The modified surface also allows extracellular matrix proteins frequently used as cell culture substrates to be readily adsorbed on its surface. A polystyrene device was created as described above in order to evaluate the biocompatibility and cell attachment of polystyrene surfaces created by the soft lithography process. After replica molding, the polystyrene microstructure possessed the native surface properties of polystyrene, i.e. inert and hydrophobic as assessed by the contact angle of water on the treated surface. Plasma treatment was required to re-generate a hydrophilic and ionic surface suitable for cell culture. H1299 cells were cultured on a standard tissue culture dish, a molded polystyrene surface subjected to a 5 min plasma treatment, and a PDMS surface that was also subjected to plasma treatment for 5 min. In three days the cells spread and attached equally well to both the tissue culture dish and molded polystyrene surfaces (FIGS. 6A and B) demonstrating that the molded polystyrene was equivalent to the TC dish in terms of cell biocompatibility. In contrast, the cell attachment and proliferation on the PDMS surface was less than that on polystyrene. These differences may relate to postoxidation hydrophobic recovery of the PDMS^{,16} and/or leaching of low molecular weight species.¹⁷

Micromolding of polymers on soft master (PDMS) by using compatible solvents. In addition to the foregoing, we have tested the following additional solute/solvent/processing conditions. #1-#4 generate solid polymers. #5 generates porous polymers.

| # | Solute | Solvent | Processing conditions |
|---|---|---|---|
| 1 | Polystyrene | gamma-Butyrolactone | 70° C. 4 hours and |
| | | gamma-Valerolactone | 100° C. 12 hours |
| 2 | Poly(methyl | gamma-Butyrolactone | 70° C. 4 hours and |
| | methacrylate) | gamma-Valerolactone | 100° C. 12 hours |
| 3 | Poly (DL-lactide) | gamma-Butyrolactone | 70° C. 4 hours and |
| | | gamma-Valerolactone | 100° C. 12 hours |
| 4 | Poly (DL-lactide- | gamma-Butyrolactone | 70° C. 4 hours and |
| | co-glycolide) | gamma-Valerolactone | 100° C. 12 hours |
| 5 | Poly (DL-lactide) | gamma-Butyrolactone | Spin coating; water |
| | | gamma-Valerolactone | soaking 1 hour; |
| | | | release from mold; |
| | | | water soaking 2 hour. |

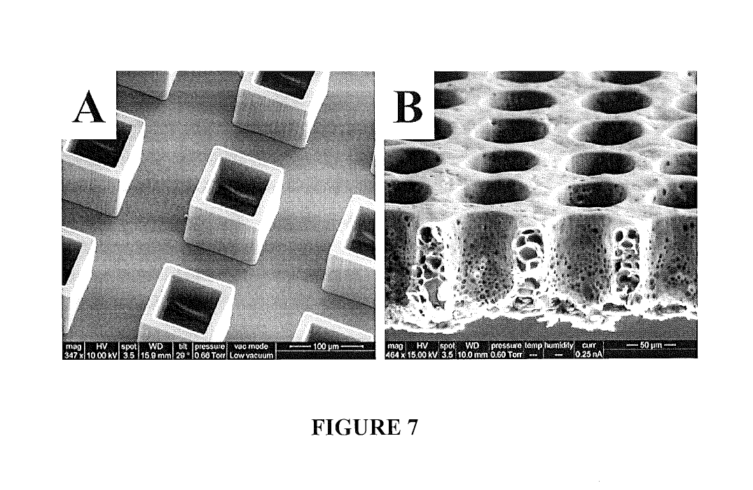

Photographs of additional examples of articles formed by the present invention are provided in FIG. 7.

### REFERENCES

1. Curtis, A. S. G. et al., Adhesion of cells to polystyrene surfaces. Journal of Cell Biology 1983, 97(5), 1500-1506.
2. Chin, C. D.; Linder, V.; Sia, S. K., Lab-on-a-chip devices for global health: Past studies and future opportunities. Lab on a Chip 2007, 7(1), 41-57.
3. Madou, M., Fundamentals of microfabrcation. CRC: New York, 2002.
4. Becker, H.; Gartner, C., Polymer microfabrication methods for microfluidic analytical applications. Electrophoresis 2000, 21(1), 12-26.
5. Becker, H.; Gartner, C., Polymer microfabrication technologies for microfluidic systems. Analytical and Bioanalytical Chemistry 2008, 390(1), 89-111.
6. Chen, Y.; Zhang, L. Y.; Chen, G., Fabrication, modification, and application of department of analytical poly(methyl methacrylate) microfluidic chips. Electrophoresis 2008, 29(9), 1801-1814.
7. Steigert, J. et al., Rapid prototyping of microfluidic chips in COC. Journal of Micromechanics and Microengineering 2007, 17(2), 333-341.
8. Barker, S. L. R. et al., Control of flow direction in microfluidic devices with polyelectrolyte multilayers. Analytical Chemistry 2000, 72, 5925-5929.
9. Barker, S. L. R. et al., Analytical Chemistry 2000, 72(20), 4899-4903.
10. Chen, C. S et al., Shrinky-Dink microfluidics: 3D polystyrene chips. Lab on a Chip 2008, 8(4), 622-624.
11, Xia, Y. N.; Whitesides, G. M., Soft lithography. Annual Review of Materials Science 1998, 28, 153-184.
12. Whitesides, G. M. et al., Annual Review of Biomedical Engineering 2001, 3, 335-373.
13. Kim, P.; et al., Soft lithography for microfluidics: a review. Biochip Journal 2008, 2, 1-11.
14. McDonald, J. C. et al., Fabrication of microfluidic systems in poly(dimethylsiloxane). Electrophoresis 2000, 21(1), 27-40.
15. Sia, S. K.; Whitesides, G. M., Microfluidic devices fabricated in poly(dimethylsiloxane) for biological studies. Electrophoresis 2003, 24(21), 3563-3576.
16. Fritz, J. L.; Owen, M. J., Hydrophobic recovery of plasma-treated polydimethylsiloxane. Journal of Adhesion 1995, 54(1-2), 33-45.
17. Regehr, K. J. et al., Biological implications of polydimethylsiloxane-based microfluidic cell culture. Lab on a Chip 2009, 9(15), 2132-2139.
18. Toepke, M. W. et al., PDMS absorption of small molecules and consequences in microfluidic applications. Lab on a Chip 2006, 6(12), 1484-1486.
19. Merkel, T. C. et al., Journal of Polymer Science Part B-Polymer Physics 2000, b 415-434.
20. Dusseiller, M. R. et al., An inverted microcontact printing method on topographically structured polystyrene chips for arrayed micro-3-D culturing of single cells. Biomaterials 2005, 26(29), 5917-5925.
21. Lee, J. N. et al., Solvent compatibility of poly(dimethylsiloxane)-based microfluidic devices. Analytical Chemistry 2003, 75(23), 6544-6554.
22. Truong, T. T. et al., Soft lithography using acryloxy perfluoropolyether composite stamps. Langmuir 2007, 23(5), 2898-2905.
23. Gratton, S. E. A. et al., The Pursuit of a Scalable Nanofabrication Platform for Use in Material and Life Science Applications. Accounts of Chemical Research 2008, b 1685-1695.
24. Wang, Y. L. et al., Micromolded arrays for separation of adherent cells. Lab on a Chip 2010, 10(21), 2917-2924.
25. Allbritton, N. et al., Array of Micromolded Structures for Sorting Adherent Cells. PCT Publication No. WO 2011/103143 (Aug. 25, 2011).
26. Huang, B. et al., Coating of poly(dimethylsiloxane) with n-dodecyl-beta-Dmaltoside to minimize nonspecific protein adsorption. Lab on a Chip 2005, 5(10), 1005-1007.
27. Roman, G. T. et al., Sol-gel modified poly(dimethylsiloxane) microfluidic devices with high electroosmotic Mobilities and hydrophilic channel wall characteristics. Analytical Chemistry 2005, 77(5), 1414-1422.
28. Occhiello, E. et al., Hydrophobic recovery of oxygen-plasma-treated polystyrene. Polymer 1992, 33(14), 3007-3015.
   The foregoing is illustrative of the present invention, and is not to be construed as limiting thereof. The invention is defined by the following claims, with equivalents of the claims to be included therein.

That which is claimed is:

1. A method of making an article, comprising:
(a) providing a reverse template for said article, said template comprising an elastomeric polymer;
(b) providing a solution comprising a polymer dissolved in a first solvent; wherein said polymer is selected from the group consisting of polystyrene, poly(methyl methacrylate), epoxy, and aliphatic polyesters; and wherein said solvent comprises a lactone;
(c) depositing said solution on said template;
(e) removing said solvent from said template to form said article from said polymer on said template; and then
(f) separating said template from said article.

2. The method of claim 1, wherein said removing step comprises baking said template.

3. The method of claim 1, wherein said removing step comprises contacting said template to a second solvent, wherein said first solvent is miscible in said second solvent, and said polymer is immiscible in said second solvent, to thereby form a porous article.

4. The method of claim 1, wherein said article has a plurality of features formed thereon.

5. The method of claim 4, said features having an aspect ratio greater than 2.

6. The method of claim 4, wherein said article has at least 100 features formed thereon, and wherein not more than 1 of said features are defective.

7. The method of claim 4, said features selected from the group consisting of columns, walls, wells, trenches, and combinations thereof.

8. The method of claim 4, wherein said features have a height or depth of from 1 μm to 10 mm, and/or a thickness or width of 1 μm to 10 mm.

9. The method of claim 1, wherein said article is selected from the group consisting of microfluidic devices, filters, microelectronic devices, microelectromechanical devices, microlenses, waveguides, filters, cell carriers, and nanoparticles.

10. The method of claim 1, wherein said elastomeric polymer comprises polydimethylsiloxane (PDMS).

11. The method of claim 1, wherein said solvent comprises gamma-butyrolactone or gamma-valerolactone.

12. The method of claim 11, wherein said polymer comprises polystyrene.

13. The method of claim 1, wherein said polymer comprises poly(methyl methacrylate)

14. The method of claim 1, wherein said polymer comprises an epoxy polymer.

15. The method of claim 1, wherein said polymer comprises aliphatic polyester.

16. The method of claim 15, wherein said aliphatic polyester comprises at least one polymer selected from polyhydroxy butyrate (PHP), polyhydroxy butyrate-co-valerate (PHBV), polycaprolactane, polybutylene succinate, polybutylene succinate-co-adipate, polyglycolic acid (PGA), polylactide or polylactic acid (PLA), polybutylene oxalate, polyethylene adipate, polyparadioxanone, polymorpholineviones, or polydioxipane-2-one.

17. An article produced by the process of claim 1.

18. A method of making an article, comprising:
(a) providing a reverse template for said article, said template comprising polydimethylsiloxane (PDMS), wherein said article has a plurality of features formed thereon;
(b) providing a solution comprising a polystyrene dissolved in a first solvent; and wherein said solvent comprises gamma-butyrolactone or gamma-valerolactone;
(c) depositing said solution on said template;
(e) removing said solvent from said template to form said article from said polymer on said template; and then
(f) separating said template from said article.

19. The method of claim 18, wherein said removing step comprises baking said template.

20. The method of claim 18, wherein said removing step comprises contacting said template to a second solvent, wherein said first solvent is miscible in said second solvent, and said polymer is immiscible in said second solvent, to thereby form a porous article.

21. The method of claim 18, said features having an aspect ratio greater than 2.

22. The method of claim 18, wherein said article has at least 100 features formed thereon, and wherein not more than 1 of said features are defective.

23. The method of claim 18, said features selected from the group consisting of columns, walls, wells, trenches, and combinations thereof.

24. The method of claim 4, wherein said features have a height or depth of from 1 μm to 10 mm, and/or a thickness or width of 1 μm to 10 mm.

25. The method of claim 1, wherein said article is selected from the group consisting of microfluidic devices, filters, microelectronic devices, microelectromechanical devices, microlenses, waveguides, filters, cell carriers, and nanoparticles.
